(19) United States
(12) Patent Application Publication
(10) Pub. No.: US 2023/0220184 A1
(43) Pub. Date: Jul. 13, 2023

(54) POLYCARBONATE RESIN COMPOSITION AND RESIN MOLDED BODY

(71) Applicant: IDEMITSU KOSAN CO.,LTD., Tokyo (JP)

(72) Inventors: Junichi TSUZUKI, Sodegaura-shi, Chiba (JP); Toshio ISOZAKI, Chiba-shi, Chiba (JP)

(73) Assignee: IDEMITSU KOSAN CO.,LTD., Tokyo (JP)

(21) Appl. No.: 18/009,901

(22) PCT Filed: Apr. 6, 2021
(86) PCT No.: PCT/JP2021/014606

§ 371 Date: Dec. 12, 2022

(30) Foreign Application Priority Data
Jun. 16, 2020 (JP) 2020-103992

(51) Int. Cl. C08K 5/526; C08G 64/04; C08K 5/103; C08K 5/1515

(52) U.S. Cl. CPC C08K 5/526; C08G 64/04; C08K 5/103; C08K 5/1515; B29C 45/0001

(57) ABSTRACT

A resin composition, including an aromatic polycarbonate resin, wherein when colorimetry is performed by using a molded body for optical characteristic measurement formed of the resin composition, the molded body including an entering portion from which light enters, an emitting portion from which the entered light is emitted, and a light-guiding portion configured to guide the light that has entered from the entering portion to the emitting portion, and the light-guiding portion including an optical path having such a curvature that the entered light is totally reflected, and by using a white light-emitting diode as a light source, a difference (Y2−Y1) between a y(Y1) of the molded body for optical characteristic measurement in a CIE 1931 color system at a position of a light-guiding path distant from the entering portion by 125 mm.

### TECHNICAL FIELD

The present invention relates to a polycarbonate resin composition and a resin molded body.

### BACKGROUND ART

An aromatic polycarbonate resin is excellent in, for example, transparency, mechanical properties, thermal properties, and electrical properties, and has been used in various optical molded articles, such as a light-guiding member, for example, a light-guiding plate, a lens, and an optical fiber, through utilization of its characteristics. In recent years, a polycarbonate resin composition has been used in light-guiding parts forming the light-guiding portions of the daytime running lights or daytime running lamps (hereinafter sometimes referred to as “DRLs”) of vehicles and the like. The DRLs are each used as a part for introducing high-output LED light into its entirety and extracting the light in a specific direction in order to improve the visibility of a vehicle. The polycarbonate resin composition to be used in a DRL for a vehicle is required to have a satisfactory initial optical characteristic (color tone) after its molding and to show a small change in color tone even when irradiated with LED light for a long time period.

In PTL 1, there is a disclosure of a technology of improving the total light transmittance, thermal deformation temperature, and falling weight impact strength of a resin composition through use of a specific spectral transmittance ratio thereof. In PTL 2, there is a disclosure of a technology for an improvement in productivity in a light-guiding part application through use of a specific molding condition. In PTL 3, there is a disclosure of a technology concerning heat-resistant yellowing suppression and heat resistance, the technology including using the phosphorus-based antioxidant, polybutylene glycol, and alicyclic epoxy compound of a resin composition.

### CITATION LIST

### Patent Literature

PTL 1: JP 3516908 B2
PTL 2: JP 6575979 B2
PTL 3: JP 2018-141093 A

### SUMMARY OF INVENTION

### Technical Problem

However, in each of the technologies disclosed in PTLs described above, a problem concerning a change in color tone of guided light in a long light-guiding path along with the elongation of a lighting tool for a vehicle and the durability of the tool at the time of its irradiation with LED light (suppression of the deterioration of the resin thereof) has not been recognized. Meanwhile, the lighting tool for a vehicle has been required to have a long lifetime, and hence the development of a resin molded body excellent in light-guiding performance, the resin molded body being useful as an internal part for the lighting tool for a vehicle, has been required.

An object to be achieved by the present invention is to provide a polycarbonate resin composition, which is suppressed from showing a change in color tone of guided light in the long light-guiding path of a resin molded body and is suppressed from deteriorating when irradiated with LED light under a moist heat environment.

### Solution to Problem

The present invention relates to the following.

<1> A resin composition, comprising an aromatic polycarbonate resin,

wherein when colorimetry is performed by using a molded body for optical characteristic measurement formed of the resin composition, the molded body including an entering portion from which light enters, an emitting portion from which the entered light is emitted, and a light-guiding portion configured to guide the light that has entered from the entering portion to the emitting portion, and the light-guiding portion including an optical path having such a curvature that the entered light is totally reflected, and by using a white light-emitting diode as a light source,

a difference (Y2−Y1) between a y(Y1) of the molded body for optical characteristic measurement in a CIE 1931 color system at a position of a light-guiding path distant from the entering portion by 125 mm and a y(Y2) thereof in the CIE 1931 color system at a position of the light-guiding path distant from the entering portion by 525 mm is 0.055 or less, and the y(Y2) thereof in the CIE 1931 color system at the position of the light-guiding path distant from the entering portion by 525 mm is 0.40 or less.

<2> The resin composition according to the above-mentioned item <1>, further comprising an antioxidant, wherein a content of the antioxidant is 0.005 part by mass or more and 0.5 part by mass or less with respect to 100 parts by mass of the aromatic polycarbonate resin.

<3> The resin composition according to the above-mentioned item <2>, wherein a 5-millimeter thick plate, which is obtained by subjecting the resin composition to injection molding under conditions of a cylinder temperature of 260° C., a die temperature of 80° C., a cycle time of 50 seconds, and a retention time of 230 seconds, contains a coloring source compound derived from the antioxidant, the coloring source compound has a conjugate number of 10 or less, and a content of the coloring source compound in the 5-millimeter thick plate is 1 ppm or less.

<4> The resin composition according to the above-mentioned item <2> or <3>, wherein the antioxidant contains at least one of a phosphorus-based antioxidant or a phenol-based antioxidant.

<5> The resin composition according to any one of the above-mentioned items <1> to <4>, wherein the aromatic polycarbonate resin has a viscosity-average molecular weight of 10,000 or more and 30,000 or less.

<6> The resin composition according to any one of the above-mentioned items <1> to <5>, further comprising a fatty acid ester, wherein a content of the fatty acid ester is 0.01 part by mass or more and 0.5 part by mass or less with respect to 100 parts by mass of the aromatic polycarbonate resin.

<7> The resin composition according to any one of the above-mentioned items <1> to <6>, wherein a 5-millimeter thick plate, which is obtained by subjecting the resin composition to injection molding under conditions of a cylinder temperature of 260° C., a die temperature of 80° C., a cycle time of 50 seconds, and a retention time of 230 seconds, has a total light transmittance of 80% or more.

<8> The resin composition according to any one of the above-mentioned items <1> to <7>, wherein a 5-millimeter thick plate, which is obtained by subjecting the resin composition to injection molding under conditions of a cylinder temperature of 260° C., a die temperature of 80° C., a cycle time of 50 seconds, and a retention time of 230 seconds, has a YI of 1.2 or less.

<9> The resin composition according to any one of the above-mentioned items <1> to <8>, wherein a 5-millimeter thick plate, which is obtained by subjecting the resin composition to injection molding under conditions of a cylinder temperature of 260° C., a die temperature of 80° C., a cycle time of 50 seconds, and a retention time of 230 seconds, has an average spectral light transmittance of 85.5% or more at a wavelength of from 340 nm to 400 nm.

<10> The resin composition according to any one of the above-mentioned items <1> to <9>, further comprising an alicyclic epoxy compound, wherein a content of the alicyclic epoxy compound is 0.01 part by mass or more and 0.5 part by mass or less with respect to 100 parts by mass of the aromatic polycarbonate resin.

<11> A resin molded body, comprising the resin composition of any one of the above-mentioned items <1> to <10>.

<12> The resin molded body according to the above-mentioned item <11>, wherein the resin molded body is an optical part.

<13> The resin molded body according to the above-mentioned item <11> or <12>,

wherein the resin composition further includes an antioxidant, and

wherein the resin molded body comprises a coloring source compound derived from the antioxidant, the coloring source compound has a conjugate number of 10 or less, and a content of the coloring source compound in the resin molded body is 1 ppm or less.

<14> A method of producing the resin molded body of any one of the above-mentioned items <11> to <13>, comprising a step of subjecting the resin composition of any one of the above-mentioned items <1> to <10> to injection molding under conditions of a cylinder temperature of 220° C. or more and 300° C. or less, and a retention time of 60 seconds or more and 1,800 seconds or less.

<15> A method of producing a resin molded body, comprising a step of obtaining the resin molded body by subjecting a resin composition including an aromatic polycarbonate resin and an antioxidant to injection molding under conditions of a cylinder temperature of 220° C. or more and 300° C. or less, and a retention time of 60 seconds or more and 1,800 seconds or less,

wherein the resin molded body includes a coloring source compound derived from the antioxidant, the coloring source compound has a conjugate number of 10 or less, and a content of the coloring source compound in the resin molded body is 1 ppm or less.

<16> The method of producing a resin molded body according to the above-mentioned item <15>, wherein the content of the coloring source compound in the resin molded body is 0.0002 ppm or less.

### Advantageous Effects of Invention

The molded body formed of the polycarbonate resin composition of the present invention is suppressed from showing a change in color tone of guided light in a long light-guiding path, and is excellent in durability at the time of its irradiation with LED light. The molded body is suitable as a light-guiding part for a vehicle and various light-guiding plates, and is particularly useful as a DRL part suppressed from showing a change in color tone of guided light in a long light-guiding path.

### DESCRIPTION OF EMBODIMENTS

An upper limit value and a lower limit value described herein for a numerical range may be arbitrarily combined.

In addition, two or more embodiments that are not contrary to each other out of the individual embodiments of an aspect according to the present invention to be described below may be combined, and an embodiment in which the two or more embodiments are combined is also an embodiment of the aspect according to the present invention.

[Resin Composition]

A resin composition of the present invention is a resin composition including an aromatic polycarbonate resin. In addition, the present invention relates to the resin composition, wherein when colorimetry is performed by using a molded body for optical characteristic measurement formed of the resin composition, the molded body including an entering portion from which light enters, an emitting portion from which the entered light is emitted, and a light-guiding portion configured to guide the light that has entered from the entering portion to the emitting portion, and the light-guiding portion including an optical path having such a curvature that the entered light is totally reflected, and by using a white light-emitting diode as a light source, a difference (Y2−Y1) between a y(Y1) of the molded body for optical characteristic measurement in a CIE 1931 color system at a position of a light-guiding path distant from the entering portion by 125 mm and a y(Y2) thereof in the CIE 1931 color system at a position of the light-guiding path distant from the entering portion by 525 mm is 0.055 or less, and the y(Y2) thereof in the CIE 1931 color system at the position of the light-guiding path distant from the entering portion by 525 mm is 0.40 or less.

Although the reason why the molded body formed of the resin composition of the present invention is excellent in optical performance and is suppressed from deteriorating when irradiated with LED light under a moist heat environment is unclear, the reason is conceived to be as described below.

It is conceived that when, at the time of the colorimetry through use of the molded body for optical characteristic measurement formed of the resin composition, the difference (Y2−Y1) between the y(Y1) of the molded body for optical characteristic measurement in the CIE 1931 color system at the position of the light-guiding path distant from the entering portion by 125 mm and the y(Y2) thereof in the CIE 1931 color system at the position of the light-guiding path distant from the entering portion by 525 mm is 0.055 or less, and the y(Y2) of the molded body for optical characteristic measurement in the CIE 1931 color system at the position of the light-guiding path distant from the entering portion by 525 mm is 0.40 or less, the absorption of light in a short-wavelength region in the light-guiding portion is reduced, and hence the deterioration and the like of the resin can be suppressed.

The resin composition of the present invention is a resin composition including the aromatic polycarbonate resin. A resin produced by a known method may be used as the aromatic polycarbonate resin without any particular limitation.

For example, a resin produced by causing a dihydric phenol and a carbonate precursor to react with each other by a solution method (interfacial polycondensation method) or a melting method (ester exchange method), i.e., a resin produced by the interfacial polycondensation method involving causing the dihydric phenol and phosgene to react with each other in the presence of an end terminator, or by causing the dihydric phenol and diphenyl carbonate or the like to react with each other in the presence of the end terminator according to the ester exchange method or the like may be used as the aromatic polycarbonate resin.

Examples of the dihydric phenol may include various dihydric phenols, in particular: bis(hydroxyphenyl)alkane-based compounds, such as 2,2-bis(4-hydroxyphenyl)propane [bisphenol A], bis(4-hydroxyphenyl)methane, 1,1-bis(4-hydroxyphenyl)ethane, and 2,2-bis(4-hydroxy-3,5-dimethylphenyl)propane; 4,4′-dihydroxydiphenyl, a bis(4-hydroxyphenyl)cycloalkane, bis(4-hydroxyphenyl) oxide, bis(4-hydroxyphenyl) sulfide, bis(4-hydroxyphenyl) sulfone, bis(4-hydroxyphenyl) sulfoxide, and bis(4-hydroxyphenyl) ketone. In addition, the examples may also include hydroquinone, resorcin, and catechol. Those dihydric phenols may be used alone or in combination thereof.

Among them, one or more kinds of bis(hydroxyphenyl)alkane-based compounds selected from the group consisting of 2,2-bis(4-hydroxyphenyl)propane [bisphenol A], bis(4-hydroxyphenyl)methane, and 1,1-bis(4-hydroxyphenyl)ethane are preferred, and bisphenol A is particularly suitable.

Examples of the carbonate precursor include a carbonyl halide, a carbonyl ester, and a haloformate. The carbonate precursor is specifically phosgene, a dihaloformate of a dihydric phenol, diphenyl carbonate, dimethyl carbonate, diethyl carbonate, or the like.

The aromatic polycarbonate resin (A) may have a branched structure. As a branching agent used for introducing a branched structure, there are given, for example, 1,1,1-tris(4-hydroxyphenyl)ethane, α,α′,α″-tris(4-hydroxyphenyl)-1,3,5-triisopropylbenzene, phloroglucin, trimellitic acid, and 1,3-bis(o-cresol).

A monovalent carboxylic acid or a derivative thereof or a monohydric phenol may be used as the end terminator. Examples thereof may include p-tert-butylphenol, p-phenylphenol, p-cumylphenol, p-perfluorononylphenol, p-(perfluorononylphenyl)phenol, p-(perfluorohexylphenyl)phenol, p-tert-perfluorobutylphenol, 1-(p-hydroxybenzyl)perfluorodecane, p-[2-(1H,1H-perfluorotridodecyloxy)-1,1,1,3,3,3-hexafluoropropyl]phenol, 3,5-bis(perfluorohexyloxycarbonyl)phenol, perfluorododecyl p-hydroxybenzoate, p-(1H,1H-perfluorooctyloxy)phenol, 2H,2H,9H-perfluorononanoic acid, and 1,1,1,3,3,3-hexafluoro-2-propanol.

It is preferred that the aromatic polycarbonate resin be a polycarbonate resin including, in a main chain thereof, a repeating unit represented by the following formula (I):

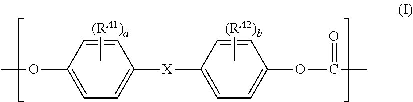

wherein R^{A1} and R^{A2} each represent an alkyl group or alkoxy group having 1 or more and 6 or less carbon atoms, and R^{A1} and R^{A2} may be identical to or different from each other, X represents a single bond, an alkylene group having 1 or more and 8 or less carbon atoms, an alkylidene group having 2 or more and 8 or less carbon atoms, a cycloalkylene group having 5 or more and 15 or less carbon atoms, a cycloalkylidene group having 5 or more and 15 or less carbon atoms, —S—, —SO—, —SO₂—, —O—, or —CO—, and “a” and “b” each independently represent an integer of 0 or more and 4 or less, when “a” represents 2 or more, R^{A1}s may be identical to or different from each other, and when “b” represents 2 or more, R^{A2}s may be identical to or different from each other.

Examples of the alkyl group represented by each of R^{A1} and R^{A2} include a methyl group, an ethyl group, a n-propyl group, an isopropyl group, various butyl groups (the term “various” means that a linear group and various branched groups are included, and the same holds true for the following), various pentyl groups, and various hexyl groups. An example of the alkoxy group represented by each of R^{A1} and R^{A2} is an alkoxy group whose alkyl group moiety is the alkyl group described above.

R^{A1} and R^{A2} each preferably represent an alkyl group having 1 or more and 4 or less carbon atoms or an alkoxy group having 1 or more and 4 or less carbon atoms.

Examples of the alkylene group represented by X include a methylene group, an ethylene group, a trimethylene group, a tetramethylene group, and a hexamethylene group. Among them, an alkylene group having 1 or more and 5 or less carbon atoms is preferred. Examples of the alkylidene group represented by X include an ethylidene group and an isopropylidene group. Examples of the cycloalkylene group represented by X include a cyclopentanediyl group, a cyclohexanediyl group, and a cyclooctanediyl group. Among them, a cycloalkylene group having 5 or more and 10 or less carbon atoms is preferred. Examples of the cycloalkylidene group represented by X include a cyclohexylidene group, a 3,5,5-trimethylcyclohexylidene group, and a 2-adamantylidene group. Among them, a cycloalkylidene group having 5 or more and 10 or less carbon atoms is preferred, and a cycloalkylidene group having 5 or more and 8 or less carbon atoms is more preferred.

“a” and “b” each independently represent an integer of 0 or more and 4 or less, preferably 0 or more and 2 or less, more preferably 0 or 1.

The aromatic polycarbonate resin preferably contains a polycarbonate resin having a bisphenol A structure from the viewpoints of, for example, the transparency, mechanical characteristics, and thermal characteristics of a molded body to be obtained. The polycarbonate resin having a bisphenol A structure is specifically, for example, such a resin that X in the formula (I) represents an isopropylidene group. The content of the polycarbonate resin having a bisphenol A structure in the aromatic polycarbonate resin is preferably 50 mass % or more and 100 mass % or less, more preferably 75 mass % or more and 100 mass % or less, still more preferably 85 mass % or more and 100 mass % or less.

From the viewpoint of flowability for molding into various shapes, the viscosity-average molecular weight (Mv) of the aromatic polycarbonate resin is preferably 10,000 or more, more preferably 11,000 or more, still more preferably 12,000 or more, and is preferably 30,000 or less, more preferably 25,000 or less, still more preferably 22,000 or less.

The viscosity-average molecular weight (Mv) as used herein is calculated from the following equation after the determination of a limiting viscosity [η] through the measurement of the viscosity of a methylene chloride solution at 20° C. with an Ubbelohde-type viscometer.

[η]=1.23×10⁻⁵Mv^{0.83}

The content of the aromatic polycarbonate resin in the resin composition is preferably 50 mass % or more, more preferably 70 mass % or more, still more preferably 85 mass % or more, still further more preferably 95 mass % or more, still further more preferably 98 mass % or more from the viewpoint that the effects of the present invention are obtained. In addition, the upper limit of the content is preferably 99.995 mass % or less.

The resin composition may include an optional additive in addition to the aromatic polycarbonate resin. Examples of the additive include an antioxidant, an alicyclic epoxy compound, and a fatty acid ester.

(Antioxidant)

The resin composition preferably includes an antioxidant from the viewpoint of preventing its coloring and the like due to the oxidative deterioration of the resin. The resin composition preferably includes at least one of a phosphorus-based antioxidant or a phenol-based antioxidant as the antioxidant.

The phosphorus-based antioxidant is preferably a phosphite-based antioxidant or a phosphine-based antioxidant from the viewpoint of obtaining a resin composition that can be suppressed from causing discoloration and the like even when retained at high temperature.

Examples of the phosphite-based antioxidant include trisnonylphenyl phosphite, triphenyl phosphite, tridecyl phosphite, trioctadecyl phosphite, tris(2,4-di-tert-butylphenyl) phosphite (e.g., product available under the product name “Irgafos 168” from BASF SE or product available under the product name “ADK STAB 2112” from ADEKA Corporation), bis-(2,4-di-tert-butylphenyl)pentaerythritol-diphosphite (e.g., product available under the product name “Irgafos 126” from BASF SE or product available under the product name “ADK STAB PEP-24G” from ADEKA Corporation), bis-(2,4-di-tert-butyl-6-methylphenyl)ethyl phosphite (e.g., product available under the product name “Irgafos 38” from BASF SE), bis-(2,6-di-tert-butyl-4-methylphenyl)pentaerythritol-diphosphite (e.g., product available under the product name “ADK STAB PEP-36” from ADEKA Corporation), distearyl-pentaerythritol-diphosphite (e.g., product available under the product name “ADK STAB PEP-8” from ADEKA Corporation or product available under the product name “JPP-2000” from Johoku Chemical Co., Ltd.), [bis(2,4-di-tert-butyl-5-methylphenoxy)phosphino]biphenyl (e.g., product available under the product name “GSY-P101” from Osaki Industry Co., Ltd.), 2-tert-butyl-6-methyl-4-[3-(2,4,8,10-tetra-tert-butylbenzo[d][1,3,2]benzodioxaphosphepin-6-yl)oxypropyl)phenol (e.g., product available under the product name “Sumilizer GP” from Sumitomo Chemical Company, Limited), tris[2-[[2,4,8,10-tetra-tert-butyldibenzo[d,f][1,3,2]dioxaphosphepin-6-yl]oxy]ethyl]amine (e.g., product available under the product name “Irgafos 12” from BASF SE), and bis(2,4-dicumylpheny)pentaerythritol diphosphite (product available under the product name “Doverphos S-9228PC” from Dover Chemical Corporation).

Among those phosphite-based antioxidants, bis(2,6-di-tert-butyl methylphenyl)pentaerythritol-diphosphite (“ADK STAB PEP-36”), bis(2,4-di-tert-butylphenyl)pentaerythritol-diphosphite, bis(2,4-dicumylphenyl)pentaerythritol diphosphite (“Doverphos S-9228PC”), and 2-tert-butyl-6-methyl-4-[3-(2,4,8,10-tetra-tert-butylbenzo[d][1,3,2]benzodioxaphosphepin-6-yl]oxypropyl]phenol (e.g., product available under the product name “Sumilizer GP” from Sumitomo Chemical Company, Limited) are preferred from the viewpoint of preventing the coloring and the like of the resin composition. Among them, bis(2,6-di-tert-butyl-4-methylphenyl)pentaerythritol-diphosphite (e.g., “ADK STAB PEP-36”) is particularly preferred.

An example of the phosphine-based antioxidant is triphenylphosphine (product available under the product name “JC263” from Johoku Chemical Co., Ltd.).

Examples of the phenol-based antioxidant include hindered phenols, such as n-octadecyl-3-(3,5-di-tert-butyl-4-hydroxyphenyl) propionate, 2,6-di-tert-butyl-4-methylphenol, 2,2′-methylenebis(4-methyl-6-tert-butylphenol), and pentaerythrityl-tetrakis[3-(3,5-di-tert-butyl-4-hydroxyphenyl)propionate].

Examples of commercially available products of the phenol-based antioxidant may include products available under the product names “Irganox 1010”, “Irganox 1076”, “Irganox 1330”, “Irganox 3114”, and “Irganox 3125” from BASF SE, a product available under the product name “BHT” from Takeda Pharmaceutical Company Limited, a product available under the product name “Cyanox 1790” from Cyanamid, and a product available under the product name “Sumilizer GA-80” from Sumitomo Chemical Company, Limited.

From the viewpoint of preventing the coloring and the like of the resin composition, the content of the antioxidant in the resin composition is preferably 0.005 part by mass or more, more preferably 0.01 part by mass or more, still more preferably 0.02 part by mass or more with respect to 100 parts by mass of the aromatic polycarbonate resin, and is preferably 0.5 part by mass or less, more preferably 0.2 part by mass or less, still more preferably 0.1 part by mass or less, still further more preferably 0.08 part by mass or less, still further more preferably 0.05 part by mass or less with respect thereto.

(Alicyclic Epoxy Compound)

The resin composition may further include an alicyclic epoxy compound from the viewpoints of improving the long-term moist heat resistance and long-term heat resistance of the molded body to be obtained, and suppressing the deterioration thereof at the time of its irradiation with LED light under a moist heat environment.

The alicyclic epoxy compound refers to a cyclic aliphatic compound having an alicyclic epoxy group, that is, an epoxy group obtained by adding one oxygen atom to an ethylene bond in an aliphatic ring, and specifically, compounds represented by the following formulae (B-1) to (B-10) are each suitably used:

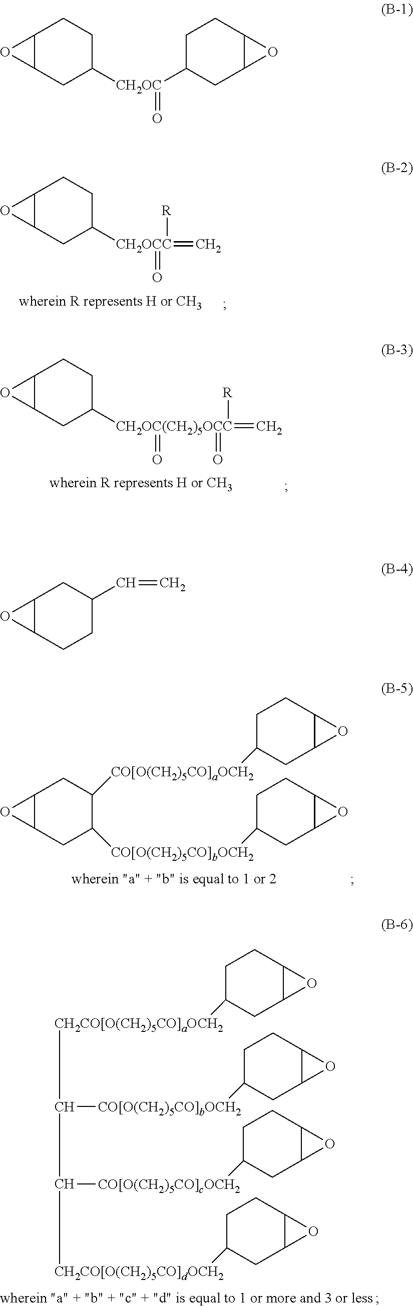

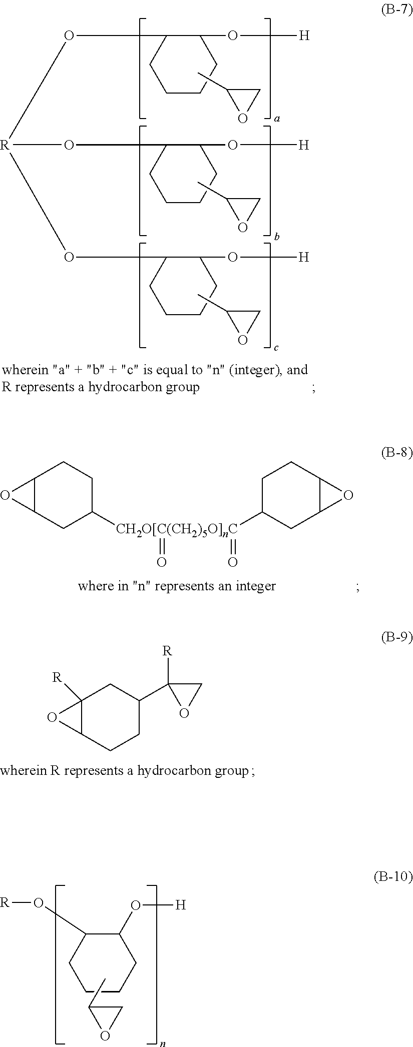

wherein “n” represents an integer and R represents a hydrocarbon group.

Among the above-mentioned alicyclic epoxy compounds, one or more kinds of compounds selected from the group consisting of the compounds represented by the formula (B-1), the formula (B-7), and the formula (B-10) are preferred because each of the compounds is excellent in compatibility with the aromatic polycarbonate resin, and hence does not impair the transparency of the polycarbonate resin composition, one or more kinds of compounds selected from the group consisting of the compounds represented by the formula (B-1) and the formula (B-10) are more preferred, and the compound represented by the formula (B-1) is still more preferred. For example, the compound represented by the formula (B-1) is available as 3′,4′-epoxycyclohexylmethyl-3,4-epoxycyclohexane carboxylate (“Celloxide 2021P” manufactured by Daicel Corporation). In addition, the compound represented by the formula (B-10) is available as a 1,2-epoxy-4-(2-oxiranyl)cyclohexane adduct of 2,2-bis(hydroxymethyl)-1-butanol (“EHPE 3150” manufactured by Daicel Corporation). In addition, “EHPE 3150CE” commercially available as a mixture of “Celloxide 2021P” and “EHPE 3150” from Daicel Corporation may also be preferably used.

When the resin composition includes the alicyclic epoxy compound, from the viewpoint of suppressing its deterioration at the time of its irradiation with LED light under a moist heat environment, the content of the alicyclic epoxy compound in the resin composition is preferably 0.01 part by mass or more, more preferably 0.02 part by mass or more, still more preferably 0.05 part by mass or more with respect to 100 parts by mass of the aromatic polycarbonate resin, and is preferably 0.5 part by mass or less, more preferably 0.2 part by mass or less with respect thereto.

(Fatty Acid Ester)

The resin composition may further include a fatty acid ester from the viewpoints of improving the long-term moist heat resistance of the molded body to be obtained, and suppressing the deterioration thereof at the time of its irradiation with LED light under a moist heat environment. The fatty acid ester is a condensate of an aliphatic carboxylic acid and an alcohol. Although the reason why the incorporation of the fatty acid ester can further improve the long-term moist heat resistance of the molded body, and further suppress the deterioration thereof at the time of the LED light irradiation under the moist heat environment is unclear, the reason is assumed to be that when the fatty acid ester having a hydrophilic unit is present in the resin composition, a water molecule present around an ester bond (carbonate bond) of the aromatic polycarbonate resin easily moves toward the fatty acid ester, and hence a reduction in molecular weight of the aromatic polycarbonate resin hardly occurs.

Examples of the aliphatic carboxylic acid include saturated or unsaturated aliphatic monocarboxylic acids, aliphatic dicarboxylic acids, aliphatic tricarboxylic acids, and aliphatic tetracarboxylic acids. Among them, one or more kinds selected from the group consisting of aliphatic monocarboxylic acids and aliphatic dicarboxylic acids are preferred, and aliphatic monocarboxylic acids are more preferred. The aliphatic carboxylic acid may be a chain aliphatic carboxylic acid or a cyclic aliphatic carboxylic acid, but is preferably a chain aliphatic carboxylic acid. The aliphatic carboxylic acid has preferably 6 or more and 40 or less carbon atoms, more preferably 8 or more and 32 or less carbon atoms, still more preferably 12 or more and 24 or less carbon atoms.

Examples of the saturated aliphatic carboxylic acids include: saturated aliphatic monocarboxylic acids, such as capric acid, neodecanoic acid, lauric acid, myristic acid, palmitic acid, stearic acid, arachidic acid, behenic acid, and lignoceric acid; and saturated aliphatic dicarboxylic acids, such as adipic acid, azelaic acid, and sebacic acid. Examples of the unsaturated aliphatic carboxylic acids include undecylenic acid, oleic acid, elaidic acid, erucic acid, nervonic acid, linoleic acid, ricinoleic acid, γ-linolenic acid, arachidonic acid, α-linolenic acid, stearidonic acid, eicosapentaenoic acid, and docosahexaenoic acid.

Among them, as the aliphatic carboxylic acid, one or more kinds selected from the group consisting of lauric acid, myristic acid, palmitic acid, stearic acid, and behenic acid are preferred, one or more kinds selected from the group consisting of palmitic acid, stearic acid, and behenic acid are more preferred, and stearic acid is still more preferred.

As the alcohol, an aliphatic alcohol is preferred, and a saturated aliphatic alcohol is more preferred. The saturated aliphatic alcohol may be a saturated chain aliphatic alcohol or a saturated cyclic aliphatic alcohol, but is preferably a saturated chain aliphatic alcohol. Those alcohols may each be a monohydric alcohol or a polyhydric alcohol. In addition, the alcohol may have a substituent, such as a fluorine atom, a chlorine atom, a bromine atom, or an aryl group. The alcohol has preferably 1 or more and 30 or less carbon atoms, more preferably 2 or more and 24 or less carbon atoms.

Specific examples of the alcohol include octanol, decanol, dodecanol, tetradecanol, stearyl alcohol, behenyl alcohol, ethylene glycol, diethylene glycol, glycerin, pentaerythritol, 2,2-dihydroxyperfluoropropanol, neopentylene glycol, ditrimethylolpropane, and dipentaerythritol.

Examples of the fatty acid ester include behenyl behenate, octyldodecyl behenate, stearyl stearate, glycerin monopalmitate, glycerin monostearate, glycerin monooleate, glycerin distearate, glycerin tristearate, pentaerythritol monopalmitate, pentaerythritol monostearate, pentaerythritol distearate, pentaerythritol tristearate, and pentaerythritol tetrastearate. Those fatty acid esters may be used alone or in combination thereof.

Among them, as the fatty acid ester, stearates are preferred, and glycerin monostearate is more preferred.

When the resin composition includes the fatty acid ester, from the viewpoints of improving the long-term moist heat resistance of the molded body to be obtained, and suppressing the deterioration thereof at the time of its irradiation with LED light under a moist heat environment, the content of the fatty acid ester in the resin composition is 0.005 part by mass or more, preferably 0.01 part by mass or more, more preferably 0.015 part by mass or more, still more preferably 0.02 part by mass or more with respect to 100 parts by mass of the aromatic polycarbonate resin. In addition, from the viewpoint of suppressing a change in color tone at the time of the molding of the resin molded body from the resin composition, the content is preferably 0.5 part by mass or less, more preferably 0.15 part by mass or less, still more preferably 0.12 part by mass or less, still further more preferably 0.08 part by mass or less, still further more preferably 0.05 part by mass or less, still further more preferably 0.03 part by mass or less with respect thereto.

<Method of Producing Resin Composition>

A method of producing the resin composition is not particularly limited, and the resin composition may be produced by mixing the aromatic polycarbonate resin and an additive to be added as required, and melting and kneading the mixture. The melting and kneading may be performed by a typically used method, for example, a method including using a single-screw extruder, a twin-screw extruder, a co-kneader, a multiple-screw extruder, or the like. In normal cases, a heating temperature (kneading temperature) at the time of the melting and kneading is appropriately selected from the range of from 220° C. to 300° C.

A production method including using a twin-screw extruder is particularly preferred as a method of obtaining the resin composition.

The method of producing the resin composition is preferably a method including melting and kneading resins including the aromatic polycarbonate resin and various additives to be added as required under the conditions of a cylinder temperature (kneading temperature) of 220° C. or more and 350° C. or less, and a retention time (also represented as “melting and kneading time”) of 20 seconds or more and 300 seconds or less.

In addition, at the time of the melting and kneading, it is preferred that an inert gas such as nitrogen be continuously supplied to purge air in the extruder from the viewpoint of obtaining a resin composition having an excellent color tone.

As a melting and kneading condition, the cylinder temperature (kneading temperature) is preferably 350° C. or less, more preferably 320° C. or less, still more preferably 300° C. or less, still further more preferably 270° C. or less, and is preferably 220° C. or more, more preferably 230° C. or more, still more preferably 250° C. or more. When the cylinder temperature is set within the ranges, the deterioration of the aromatic polycarbonate resin in each of the resin composition and the resin molded body is suppressed, and the modification of each of the additives is suppressed. Thus, the optical characteristics of the composition and the molded body can be made satisfactory.

As a melting and kneading condition, a screw revolution number is preferably 500 rpm or less, more preferably 400 rpm or less, still more preferably 200 rpm or less, and is preferably 30 rpm or more, more preferably 50 rpm or more, still more preferably 100 rpm or more. When the screw revolution number is set within the ranges, the resin composition becomes uniform, and hence a resin composition having uniform quality can be obtained.

From the viewpoint of suppressing the modification of each of the additives in the resin composition and the resin molded body to make the optical characteristics of the composition and the molded body satisfactory, the melting and kneading time is preferably 300 seconds or less, more preferably 200 seconds or less, still more preferably 100 seconds or less, still further more preferably 90 seconds or less, still further more preferably 80 seconds or less. In addition, when the melting and kneading time is excessively short, the resin composition does not have any uniform composition, and hence a variation in quality of the resin molded body is liable to occur. Accordingly, from the viewpoint of obtaining uniform composition of each of the resin composition and the resin molded body to suppress the variation in quality, the melting and kneading time is preferably 20 seconds or more, more preferably 30 seconds or more, still more preferably 50 seconds or more. The melting and kneading time may be changed by appropriately changing the size and ejection amount of a melting and kneading apparatus.

The shape of the resin composition of the present invention is, for example, a pellet shape or a strand shape, and is preferably a pellet shape.

(Physical Properties of Resin Composition)

From the viewpoint of suppressing a change in color tone of guided light in the long light-guiding path of an internal part for a lighting tool for a vehicle, the total light transmittance of a 5-millimeter thick plate obtained by subjecting the resin composition to injection molding is preferably 80% or more, more preferably 85% or more, still more preferably 88% or more, still further more preferably 90% or more. The total light transmittance is preferably as high as possible, and hence its upper limit is not particularly limited. However, the total light transmittance is, for example, 100% or less, and may be 98% or less or 95% or less. The total light transmittance is measured in conformity with JIS K7361-1:1997.

From the viewpoint of suppressing the change in color tone of the guided light in the long light-guiding path of the internal part for the lighting tool for a vehicle, the YI of the 5-millimeter thick plate obtained by subjecting the resin composition to injection molding is preferably 1.2 or less, more preferably 1.1 or less, still more preferably 1.08 or less, still further more preferably 1.06 or less, still further more preferably 1.04 or less, still further more preferably 1.03 or less, still further more preferably 1 or less. The YI is preferably as low as possible, and hence its lower limit is not particularly limited. However, the YI is, for example, 0.1 or more, and may be 0.5 or more or 0.8 or more.

From the viewpoint of suppressing the change in color tone of the guided light in the long light-guiding path of the internal part for the lighting tool for a vehicle, the average spectral light transmittance of the 5-millimeter thick plate obtained by subjecting the resin composition to injection molding at a wavelength of from 340 nm to 400 nm is preferably 65% or more, more preferably 80% or more, still more preferably 83% or more, still further more preferably 85% or more, still further more preferably 85.5% or more. The average spectral light transmittance is preferably as high as possible, and hence its upper limit is not particularly limited. However, the average spectral light transmittance is, for example, 100% or less, and may be 98% or less, 95% or less, or 90% or less.

The 5-millimeter thick plate obtained by subjecting the resin composition to injection molding, the plate satisfying the above-mentioned physical properties, is produced under the conditions of a cylinder temperature of 260° C., a die temperature of 80° C., a cycle time of 50 seconds, and a retention time of 230 seconds. Specifically, the 5-millimeter thick plate is obtained by a method described in Examples to be described later.

In the resin composition of the present invention, the colorimetry is performed by using the molded body for optical characteristic measurement formed of the resin composition. The molded body for optical characteristic measurement includes the entering portion from which light enters, the emitting portion from which the entered light is emitted, and the light-guiding portion configured to guide the light that has entered from the entering portion to the emitting portion, and the light-guiding portion includes the optical path having such a curvature that the entered light is totally reflected.

The entering portion is the starting end surface of the molded body for optical characteristic measurement, and the arrangement of a light source having a predetermined wavelength region near the portion causes light from the light source to enter the light-guiding portion from the starting end surface. The light-guiding portion includes the optical path for guiding the entered light from the entering portion to the emitting portion in order to propagate the entered light in the light-guiding portion and to emit the light from the emitting portion. The emitting portion has a function of controlling the propagation direction of the light, which has been caused to enter from the entering portion and has propagated in the optical path, to emit the light to the outside of the light-guiding path of the molded body. The light caused to enter the entering portion from the light source is extracted from the emitting portion (prism) of a structure shaped on the surface of the molded body for optical characteristic measurement. The shape of the emitting portion is set to a stripe pattern (prism shape).

In the molded body for optical characteristic measurement, a light-guiding path length from the entering portion to the emitting portion at a light-guiding terminal needs to be at least 525 mm, at least two emitted light portions are arranged on the path from the entering portion to the emitting portion at the light-guiding terminal, and “y” values in the CIE 1931 color system are measured at at least positions distant from the entering portion by 125 mm and 525 mm.

Reference may be made to the description of JP 2016-090229 A for the molded body for optical characteristic measurement. In the present invention, the molded body for optical characteristic measurement is produced under the conditions of a cylinder temperature of 260° C., a die temperature of 80° C., a cycle time of 40 seconds, and a retention time of 415 seconds. Specifically, the molded body for optical characteristic measurement is obtained by a method described in Examples to be described later.

In the colorimetry of the resin composition of the present invention, the white light-emitting diode is used as the light source.

When the molded body formed of the resin composition of the present invention is applied to, for example, an internal part for a lighting tool for a vehicle, a light source to be used at the time is not particularly limited, but for example, the following light sources may each be used: artificial light sources, such as a candle, a torch, a lamp, limelight, an acetylene lamp, an incandescent lamp, a fluorescent lamp, an arc lamp, an electrodeless discharge lamp, an HID lamp, a low-pressure discharge lamp, a light-emitting diode, a cold-cathode fluorescent tube, an external electrode fluorescent tube, electroluminescence light, laser, a radiation, organic electroluminescence, and a luminous paint; and natural light sources, such as sunlight, lightning, and an aurora. Among them, electroluminescence light, organic electroluminescence, a light-emitting diode, or the like may be suitably used. The number of the light sources is not particularly limited, and at least one light source may be used. In addition, light to be emitted from the light source may be white light or chromatic light.

When the colorimetry is performed by using the molded body for optical characteristic measurement and by using the white light-emitting diode as the light source, the y(Y2) of the molded body in the CIE 1931 color system at the position of the light-guiding path distant from the entering portion by 525 mm is 0.40 or less, preferably 0.395 or less, more preferably 0.39 or less. The y(Y2) is preferably as small as possible, and hence its lower limit is not particularly limited. However, the y(Y2) is, for example, 0.10 or more, and may be 0.20 or more, 0.30 or more, or 0.35 or more.

When the colorimetry is performed by using the molded body for optical characteristic measurement and by using the white light-emitting diode as the light source, the difference (Y2−Y1) between the y(Y1) of the molded body for optical characteristic measurement in the CIE 1931 color system at the position of the light-guiding path distant from the entering portion by 125 mm and the y(Y2) thereof in the CIE 1931 color system at the position of the light-guiding path distant from the entering portion by 525 mm is 0.055 or less, preferably 0.050 or less, more preferably 0.045 or less, still more preferably 0.042 or less, still further more preferably 0.040 or less from the viewpoint of suppressing a change in color tone of guided light in the long light-guiding path of an internal part for a lighting tool for a vehicle. The difference (Y2−Y1) is preferably as small as possible, and hence its lower limit is not particularly limited. However, the difference is, for example, 0.010 or more, and may be 0.020 or more, 0.025 or more, or 0.030 or more.

[Resin Molded Body]

A resin molded body of the present invention includes the resin composition of the present invention. The molded body may be produced through use of a melt-kneaded product of the resin composition or a pellet thereof obtained through melting and kneading as a raw material by an injection molding method, an injection compression molding method, an extrusion molding method, a blow molding method, a press molding method, a vacuum molding method, an expansion molding method, or the like. In particular, the molded body is preferably produced through use of the resultant pellet by an injection molding method or an injection compression molding method. A method of producing the resin molded body (also referred to as “production method according to the first aspect of the present invention”) is preferably a method including a step of subjecting the resin composition including the aromatic polycarbonate resin to injection molding under the conditions of a cylinder temperature of 220° C. or more and 300° C. or less, and a retention time of 60 seconds or more and 1,800 seconds or less. In addition, at the time of the molding, it is preferred that an inert gas such as nitrogen be continuously supplied to purge air in an extruder from the viewpoint of obtaining a resin molded body having an excellent color tone.

With regard to injection molding conditions, the cylinder temperature is preferably 300° C. or less, more preferably 280° C. or less, still more preferably 270° C. or less, and is preferably 220° C. or more, more preferably 230° C. or more. In addition, a die temperature is preferably 70° C. or more and 140° C. or less.

From the viewpoints of the optical characteristics of the molded body, a cycle time is preferably 300 seconds or less, more preferably 200 seconds or less, still more preferably 150 seconds or less. In addition, when the cycle time is excessively short, sufficient cooling is not performed up to the inside of the molded body, and hence the surface of the molded body is liable to roughen. Accordingly, from the viewpoint of obtaining a satisfactory surface roughness of the molded body, the cycle time is preferably 10 seconds or more, more preferably 20 seconds or more. The adoption of termination molding to be described later can make the cycle time shorter than those described above.

From the viewpoints of the optical characteristics of the molded body, the retention time is preferably 1,800 seconds or less, more preferably 1,500 seconds or less, still more preferably 1,000 seconds or less, still further more preferably 500 seconds or less. In addition, from the viewpoint of obtaining a satisfactory surface roughness of the molded body, the retention time is preferably 60 seconds or more, more preferably 100 seconds or more.

In general, the injection molding includes a step of plasticizing and metering a raw material resin, an injecting step, a cooling step, and a product-removing step, and these steps are repeated as one cycle. A time period required for the one cycle is referred to as “cycle time.” To obtain excellent optical characteristics, the shortening of the injecting step and the cooling step is required. A time period required for cooling becomes longer in proportion to the square of a product wall thickness, and hence the shortening of the cooling step is difficult in a thick-walled molded article. In view of the foregoing, the shortening of the injecting step becomes important. The inventors have made extensive investigations, and as a result, have found that so-called termination molding is preferably performed for the shortening of the injecting step. The injecting step includes a filling step and a pressure-holding step. In the termination molding, high-speed filling is performed for shortening the time period of the filling step, and the time period of the pressure-holding step is shortened by eliminating screw movement at the time of the pressure-holding step to hasten the start of gate sealing. Specifically, the termination molding is a molding method in which even when an actual shot amount varies to some extent, such setting as described below is not performed: a molten resin amount (so-called cushion amount) that should serve as a margin for absorbing the variation in shot amount is added to the amount of a molten resin to be originally injected. When such termination molding is performed, defective phenomena, such as a sink mark and air bubbles, can be reduced particularly at the time of the molding of a part having a thick-walled complicated shape. Although the reason why the termination molding can reduce the defective phenomena is unclear, possible factors for the reduction are, for example, as follows: even at the time of the completion of a holding time, a residual pressure is observed, and hence a molded article is in close contact with a die surface; and a gate pressure reduces in the pressure-holding step, but does not completely reduce to 0 MPa, and hence the backflow of the resin is suppressed.

In this description, the retention time of the resin molded body is calculated from the following equation:

retention time=maximum injection volume (cc)/volume of one shot (cc)×2×molding period (second(s))=maximum metered value (mm)/[metered value (mm)-cushion amount (mm)]×2×molding period (second(s))

wherein the molding period represents the cycle time. The actual number 2 in the equation is a value calculated by using an actual molding machine.

As described above, the method of producing the resin composition of the present invention is not particularly limited. However, the composition may be produced by mixing the aromatic polycarbonate resin and an additive to be added as required, and melting and kneading the mixture. Herein, the inventors of the present invention have found that an additive having an antioxidant effect is liable to decompose in a production process for the composition or a molding process therefor particularly under the influence of heat. Further, the inventors have found that the decomposition product (primary decomposition product) decomposes to produce a coloring source compound (secondary decomposition product). In addition, the inventors have found that even the resin composition of the present invention and the resin molded body including the resin composition each include the decomposition product of the additive and the coloring source compound. The decomposition product and the coloring source compound cause the discoloration of each of the resin composition and the resin molded body including the resin composition to deteriorate the appearance of the molded body and the color tone of guided light. The inventors have also found that the production of each of the decomposition product and the coloring source compound tends to be accelerated in a high-temperature and moist heat environment.

In the case of, for example, bis-(2,6-di-tert-butyl-4-methylphenyl)pentaerythritol diphosphite (product available under the product name “ADK STAB PEP-36” from ADEKA Corporation), its thermal decomposition or hydrolysis may provide, for example, a compound having a conjugated structure in which two 2,6-di-tert-butyl-p-cresol-like structures are modified, and a quinone methide (conjugate number=3) and a stilbenequinone (conjugate number=6) represented below are specifically given.

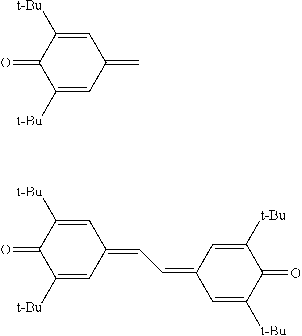 [SMILES: C=C1C=C(C(C)(C)C)C(=O)C(C(C)(C)C)=C1 ; CC(C)(C)C1=CC(=CC=C2C=C(C(C)(C)C)C(=O)C(C(C)(C)C)=C2)C=C(C(C)(C)C)C1=O]

In the case of, for example, bis(2,4-dicumylphenyl)pentaerythritol diphosphite (product available under the product name “Doverphos S-9228PC” from Dover Chemical Corporation), its thermal decomposition or hydrolysis provides a compound having the following structure (conjugate number=2).

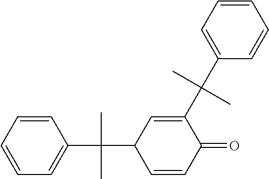 [SMILES: CC(C)(C1=CC(C(C)(C)c2ccccc2)C=CC1=O)c1ccccc1]

In the case of, for example, tris(2,4-di-tert-butylphenyl) phosphite (product available under the product name “Irgafos 168” from BASF SE or product available under the product name “ADK STAB 2112” from ADEKA Corporation), its thermal decomposition or hydrolysis provides a compound having the following structure (conjugate number=2).

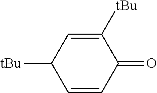 [SMILES: CC(C)(C)C1=CC(C(C)(C)C)C=CC1=O]

In the case of, for example, 2-tert-butyl-6-methyl-4-[3-(2,4,8,10-tetra-tert-butylbenzo[d][1,3,2]benzodioxaphosphepin-6-yl)oxypropyl]phenol (product available under the product name “Sumilizer GP” from Sumitomo Chemical Company, Limited), its thermal decomposition or hydrolysis provides three compounds having the following structures (each having a conjugate number of 2).

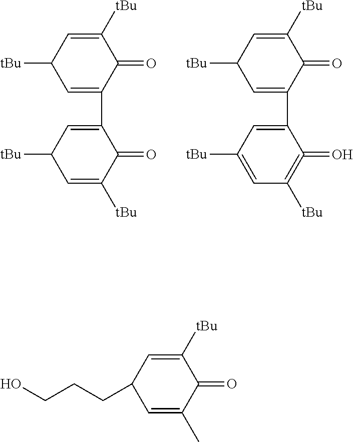

The inventors of the present invention have made extensive investigations, and as a result, have assumed that such n-conjugated compound not only serves as a coloring source compound to yellow a molded article itself but also serves as one cause for a change in color tone of guided light. In addition, the inventors have found that particularly in the case where the conjugate number of such compound is large, even when the compound is produced at a low density, the color tone of guided light in a test piece (also referred to as “molded piece”) having a long light-guiding path is affected. The conjugate number of such coloring source compound derived from an antioxidant is preferably 10 or less, more preferably 6 or less, still more preferably 3 or less.

The term “conjugate number” as used herein refers to the number of adjacent double bonds when an unsaturated bond and a single bond alternately lie in a row in a compound. That is, the conjugate number of the structure “double bond-single bond” is defined as 1, and the conjugate number of the structure “double bond-single bond-double bond” is defined as 2. For example, ethylene has a conjugate number of 1, butadiene has a conjugate number of 2, hexatriene has a conjugate number of 3, and 1,3-pentadiene has a conjugate number of 2.

When the resin molded body including the resin composition of the present invention, or a 5-millimeter thick plate, which is obtained by subjecting the resin composition to injection molding under the conditions of a cylinder temperature of 260° C., a die temperature of 80° C., a cycle time of 50 seconds, and a retention time of 230 seconds, contains a coloring source compound derived from an antioxidant, the content of the coloring source compound in the resin molded body or the 5-millimeter thick plate is preferably 1 ppm or less, more preferably 0.1 ppm or less, still more preferably 0.01 ppm or less, still further more preferably 0.001 ppm or less, still further more preferably 0.0002 ppm or less. The combination of the conjugate number and content of the coloring source compound affects the color tone of guided light in the resin molded body. Accordingly, it is preferred that the conjugate number of the coloring source compound be 10 or less, and the content thereof be 0.01 ppm or less, it is more preferred that the conjugate number thereof be 6 or less, and the content thereof be 0.1 ppm or less, it is still more preferred that the conjugate number thereof be 6 or less, and the content thereof be 0.05 ppm or less, it is still further more preferred that the conjugate number thereof be 6 or less, and the content thereof be 0.01 ppm or less, it is still further more preferred that the conjugate number thereof be 6 or less, and the content thereof be 0.001 ppm or less, and it is still further more preferred that the conjugate number thereof be 6 or less, and the content thereof be 0.0002 ppm or less. The content of the coloring source compound is preferably as small as possible, and hence its lower limit is not particularly limited, but the content may be, for example, 0.00001 ppm or more. Herein, the kind of the coloring source compound in the resin molded body or the 5-millimeter thick plate is not particularly limited, and two or more different kinds of compounds may be incorporated thereinto.

The content of the coloring source compound in each of the resin composition, the resin molded body, and the 5-millimeter thick plate may be measured by any one of GC/MS or LC/MS, and UV-vis.

The resin molded body of the present invention is excellent in optical performance, and is suppressed from deteriorating when irradiated with LED light under a moist heat environment, and is hence preferably an optical part in order that its features may be exploited. The optical part may be, for example, a lighting part for a vehicle, and is particularly preferably a DRL part. In particular, the length of the light-guiding path of the resin molded body from its entering portion to its emitting portion is preferably 100 mm or more, more preferably 200 mm or more, still more preferably 500 mm or more, still further more preferably 700 mm or more, still further more preferably 1,000 mm or more. A plurality of emitting portions may be arranged in the resin molded body.

[Method of Producing Resin Molded Body]

A method of producing the resin molded body according to the second embodiment of the present invention (also referred to as “production method according to the second aspect of the present invention”) includes a step of obtaining the resin molded body by subjecting a resin composition including an aromatic polycarbonate resin and an antioxidant to injection molding under conditions of a cylinder temperature of 220° C. or more and 300° C. or less, and a retention time of 60 seconds or more and 1,800 seconds or less. In addition, the resultant resin molded body includes a coloring source compound derived from the antioxidant, the coloring source compound has a conjugate number of 10 or less, and the content of the coloring source compound in the resin molded body is 1 ppm or less.

The production method according to the second aspect of the present invention can provide a resin molded body that is suppressed from showing a change in color tone of guided light in a long light-guiding path, and is excellent in durability at the time of its irradiation with LED light. The molded body is suitable as a light-guiding part for a vehicle and various light-guiding plates, and is particularly useful as a DRL part suppressed from showing a change in color tone of guided light in a long light-guiding path.

In addition, a method of producing the resin composition in the production method according to the second aspect of the present invention and a preferred aspect thereof, and the kinds and blending ratios of the respective components in the resin composition and preferred aspects thereof are the same as the aspects in the production method according to the first aspect of the present invention described above.

The injection molding conditions of the step of obtaining the resin molded body in the production method according to the second aspect of the present invention and preferred aspects thereof are the same as the aspects in the production method according to the first aspect of the present invention described above.

In addition, the coloring source compound derived from the antioxidant in the resin molded body obtained by the production method according to the second aspect of the present invention and a preferred aspect thereof, and the content of the coloring source compound in the resin molded body and a preferred aspect thereof are the same as the aspects in the production method according to the first aspect of the present invention described above.

### EXAMPLES

The present invention is more specifically described below by way of Examples, but the present invention is not limited to these Examples.

Components used in Examples and Comparative Examples are as described below.

Aromatic polycarbonate resin (a): “TARFLON FN1500” (manufactured by Idemitsu Kosan Co., Ltd., viscosity-average molecular weight (Mv)=14,400)

Antioxidant (b-1): “ADK STAB PEP-36” (manufactured by ADEKA Corporation, bis(2,6-di-tert-butyl-4-methylphenyl)pentaerythritol-diphosphite)

Antioxidant (b-2): “ADK STAB 2112” (manufactured by ADEKA Corporation, tris(2,4-di-tert-butylphenyl) phosphite)

Antioxidant (b-3): “Doverphos S-9228PC” (manufactured by Dover Chemical Corporation, bis(2,4-dicumylphenyl)pentaerythritol diphosphite)

Antioxidant (b-4): “Sumilizer GP” (manufactured by Sumitomo Chemical Company, Limited, 2-tert-butyl-6-methyl-4-[3-(2,4,8,10-tetra-tert-butylbenzo[d][1,3,2]benzodioxaphosphepin-6-yl)oxypropyl]phenol)

Alicyclic epoxy compound (c-1): “Celloxide 2021P” (manufactured by Daicel Corporation, 3′,4′-epoxycyclohexylmethyl-3,4-epoxycyclohexane carboxylate)

Fatty acid ester (d-1): “S-100A” (manufactured by Riken Vitamin Co., Ltd., glycerin monostearate)

TABLE 1

| | | | Conjugate | |
|---|---|---|---|---|
| | | | number of | |
| | | | coloring source | |
| | Name | Corporation | compound | |
| Antioxidant (b-1) | ADK STAB PEP- | ADEKA | 3 | 6 |
| | 36 | Corporation | | |
| Antioxidant (b-2) | ADK STAB 2112 | ADEKA | 2 | — |
| | | Corporation | | |
| Antioxidant (b-3) | Doverphos S- | Dover | 2 | — |
| | 9228PC | Chemical | | |
| | | Corporation | | |
| Antioxidant (b-4) | Sumilizer GP | Sumitomo | 2 | 3 |
| | | Chemical | | |
| | | Company, | | |
| | | Limited | | |
| Alicyclic epoxy | Celoxide 2021P | Daicel | — | — |
| compound (c-1) | | Corporation | | |
| Fatty acid ester | S-100A | Riken | — | — |
| (d-1) | | Vitamin Co., | | |
| | | Ltd. | | |

### Examples 1 to 12 and Comparative Examples 1 to 6

### (Production of Resin Composition)

The respective components shown in Table 6 were collectively mixed with a twin-screw extruder (manufactured by Toshiba Machine Co., Ltd., “TEM-26SS”, L/D=48, vented) while its cylinder temperature was set to 260° C. The resin kneaded product was supplied from the main throat portion of the extruder with a metering feeder, and was extruded into a strand shape under kneading conditions A or B shown in Table 2. The extrudate was rapidly cooled in a strand bath and cut with a strand cutter to provide a pellet-shaped resin composition. Herein, at the time of the melting and kneading, nitrogen was continuously supplied into the twin-screw extruder so that air in the cylinder was purged with nitrogen.

TABLE 2

| | | | | | Resin |
|---|---|---|---|---|---|
| | Kneading | | Screw | | temperature |
| | temper- | Ejection | revolution | Retention | at outlet |
| | ature | amount | number | time | of die |
| | (° C.) | (kg/h) | (rpm) | (minute(s)) | (° C.) |
| Kneading | 260 | 20 | 150 | 0.92 | 285 |
| conditions | | | | | |
| A | | | | | |
| Kneading | 260 | 10 | 250 | 1.58 | 293 |
| conditions | | | | | |
| B | | | | | |

(Production of Molded Body for Optical Characteristic Measurement)

The pellet-shaped resin composition obtained in the foregoing was molded into an Archimedean spiral-shaped molded body for optical characteristic measurement measuring 10 mm wide by 3 mm thick by 1,100 mm long with an injection molding machine (manufactured by Niigata Machine Techno Co., Ltd., “MD350S7000”: screw diameter: 35 mm). In addition, the resin pellet was dried at 120° C. for 5 hours immediately before the molding because the pellet could absorb moisture.

In the production of a test piece, a die whose surface had been subjected to mirror finish by being polished with a polishing agent having a grain size of 1,000 meshes was used as a die portion corresponding to the surface of a light-guiding portion (portion through which light in the molded body passed).

The emitted light portions (125 mm and 525 mm) of the molded body for optical characteristic measurement were subjected to die surface processing to have fine stripe patterns (prism shapes) (surface roughness Sa=4 μm). Each test piece was molded under molding conditions A1 or B1 shown in Table 3, and each test piece was subjected to annealing treatment at 120° C. for 5 hours. Test piece shapes are shown in Table 4.

TABLE 3

| | |
|---|---|
| Temperature (° C.) | Time (second(s)) |

| | Cylinder | Die | Cycle | Retention |
|---|---|---|---|---|
| Molding | 260 | 80 | 40 | 415 |
| conditions A1 | | | | |
| Molding | 280 | 80 | 180 | 1,869 |
| conditions B1 | | | | |

TABLE 4

| Light- | | | |
|---|---|---|---|
| guiding | Emitted light portion | | |
| portion | | Surface | Extraction |
| Surface | Surface | roughness | position |
| shape | shape | (μm) | (mm) |

| | | | | | |
|---|---|---|---|---|---|
| Test piece | Mirror | Stripe | 4 | 125 | 525 |
| shape | finish | pattern | | | |

(Production of 5-Millimeter Thick Plate)

The pellet-shaped resin composition obtained in the foregoing was molded into a 5-millimeter thick plate test piece measuring 50 mm by 90 mm by 5 mm thick with an injection molding machine (manufactured by Nissei Plastic Industrial Co., Ltd., “ES1000”: screw diameter: 26 mm). In addition, the resin pellet was dried at 120° C. for 5 hours immediately before the molding because the pellet could absorb moisture. Each test piece was molded under molding conditions A2 or B2 shown in Table 5.

TABLE 5

| | |
|---|---|
| Temperature (° C.) | Time (second(s)) |

| | Cylinder | Die | Cycle | Retention |
|---|---|---|---|---|
| Molding | 260 | 80 | 50 | 230 |
| conditions A2 | | | | |
| Molding | 280 | 80 | 450 | 1,801 |
| conditions B2 | | | | |

[Evaluation]

(Kind and Content of Coloring Source Compound Derived from Antioxidant in Molded Body for Optical Characteristic Measurement)

Measurement was performed by a method described in the following section “(Kind and Content of Coloring Source Compound derived from Antioxidant in Resin Molded Body).” At this time, the measurement was performed by using a molded body for optical characteristic measurement as a test piece.

### (Change in Color Tone of Molded Body for Optical Characteristic Measurement)

The molded body for optical characteristic measurement was subjected to measurement with the following apparatus.

### <Conditions for LED Light Irradiation>

A distance between the end portion of the test piece in the central portion of the molded body for optical characteristic measurement and an LED was set to 2 mm, and an LED light source (Nichia Corporation, “NSFW036CT”) was used as the LED. The power consumption and irradiation intensity of the light source were set to 0.35 A×3.5 V and 23 lm, respectively, and light was applied from an end surface of the molded body for optical characteristic measurement.

### <Measurement of Color Tone of Guided Light>

The luminance and chromaticity of light emitted from the molded body for optical characteristic measurement irradiated with the light under <Conditions for LED Light Irradiation> described above were measured with a spectral radiance meter (manufactured by Konica Minolta, Inc., “CS-2000”). The emitted light was extracted from each of positions distant from the light-entering portion of the molded body by 125 mm and 525 mm, and was evaluated. The resultant values were represented in the CIE 1931 color system, and when the “y” of the emitted light was more than 0.4, it was judged that the yellow tinge thereof became higher.

(Total Light Transmittance of 5-Millimeter Thick Plate)

The total light transmittance of each of the resultant test pieces was measured in conformity with JIS K7361-1:1997 with a haze meter (manufactured by Suga Test Instruments Co., Ltd., model: “HGM-2DP”).

(Average Spectral Light Transmittance of 5-Millimeter Thick Plate)

The average spectral light transmittance (%) of each of the resultant test pieces at a wavelength of from 340 nm to 400 nm was measured with a spectrophotometer (manufactured by Hitachi High-Tech Corporation, “U-4100”).

(YI of 5-Millimeter Thick Plate)

Each of the resultant pellets was subjected to injection molding to mold a flat plate-shaped test piece, and its yellow index (YI) value was measured with “SZ-Σ90” manufactured by Nippon Denshoku Industries Co., Ltd. in conformity with JIS K7373:2006. A higher numerical value of the YI means that the test piece has a higher yellowness, and is hence colored to a larger extent.

(Evaluation of 5-Millimeter Thick Plate for LED Resistance)

### <Conditions for LED Light Irradiation>

A distance between each of the resultant test pieces and an LED was set to 2 mm, and OSW4XAHAEIE manufactured by OptoSupply Limited was used as the LED light source. The power consumption of the LED and the irradiation intensity of the LED were set to 10 W (1 A×10 V) and 850 lm, respectively, and the test piece was irradiated with light from the LED. At this time, the LED light irradiation was performed in a test environment at 80° C. and 20% for 200 hours.

### <FT-IR Measurement>

The surface of the test piece after the LED light irradiation was subjected to FT-IR measurement under the following conditions.

Apparatus: A microscopic FT-IR apparatus (manufactured by Thermo Fisher Scientific K.K., model: “Nicolet 8700” (IR irradiation portion), “CONTINUUM” (microscopic portion)).

Measurement method: An attenuated total reflection method (ATR)

Measurement wavenumber range: 650 cm⁻¹ to 4,000 cm⁻¹

Resolution: 4 cm⁻¹

Measurement conditions: An infrared ray is applied by using a germanium crystal at an incident angle of 29°.

Measurement range: A range measuring about 100 μm by about 100 μm at the center of the LED light-irradiated portion of the flat plate-shaped test piece (molded body (1))

Number of scans: 200 times

The ratio (peak intensity at a wavenumber of 1,686 cm⁻¹/peak intensity at a wavenumber of 1,776 cm⁻¹) of a peak intensity at a wavenumber of 1,686 cm⁻¹ to a peak intensity at a wavenumber of 1,776 cm⁻¹ when an absorbance at a wavenumber of 1,950 cm⁻¹ in the resultant FT-IR measurement chart in which an axis of ordinate indicated an absorbance and an axis of abscissa indicated a wavenumber was defined as a baseline was determined, and was evaluated by the following criteria.

A: The peak intensity ratio is 0.3 or less.

B: The peak intensity ratio is more than 0.3 and 0.5 or less.

C: The peak intensity ratio is more than 0.5 and 0.8 or less.

D: The peak intensity ratio is more than 0.8 and 1.2 or less.

E: The peak intensity ratio is more than 1.2 and 2.0 or less.

In this evaluation, a test piece ranked earlier in the alphabetical order was judged to be more excellent in performance.

(Kind and Content of Coloring Source Compound Derived from Antioxidant in Resin Molded Body (5-Millimeter Thick Plate Test Piece))

Each of the resultant test pieces was loaded into a Geer oven, and was left to stand at 140° C. for 1,000 hours, 2,000 hours, 3,000 hours, or 5,000 hours. At this time, the above-mentioned 5-millimeter thick plates were used as the test pieces. In addition, the YI value of each test piece at that time was measured by the method described in the section “(YI of 5-millimeter Thick Plate).” The test piece after each heat resistance test was pulverized and dissolved in chloroform, and then acetone was added to the solution, followed by the removal of a precipitated resin content. The solution after the removal of the resin content was concentrated, and components whose coloring had been observed with naked eyes or a UV detector were separated from the concentrated solution through use of preparative GPC. The resultant respective components were dried in a vacuum to be solidified, and their dry weight was measured. Those components were dissolved in a solvent capable of solving the components again, and the solution was subjected to UV-vis measurement so that the maximum absorption wavelength and absorbance of a coloring source compound were measured. In addition, the molecular weight of the coloring source compound in the resultant respective components was qualitatively determined with the UV detector of a high performance liquid chromatography mass spectrometer (LC/MS). In addition, the molar extinction coefficient of the coloring source compound was calculated from the equation of Lambert-Beer's law by using the molecular weights of the colored components and their weight at the time of their drying and solidification (solution concentration at the time of the measurement), an optical path length at the time of the measurement, and the measurement result of the absorbance.

The amount of the coloring source compound was qualitatively and quantitatively determined from information obtained from the UV-vis and the high performance liquid chromatography mass spectrometer (LC/MS), and the concentration thereof present in the test piece after the heat resistance test was calculated. The point of the concentration of the coloring source compound in each of the resultant test pieces and the YI value of the test piece was plotted on a graph.

The YI values of the test pieces before the heat resistance tests were measured by the method described in the section “(YI of 5-millimeter Thick Plate).” The resultant YI values of the test pieces before the heat resistance tests were plotted on the graph of the YI values of the test pieces after the heat resistance tests and the concentrations of the coloring source compounds obtained in the foregoing, and the production amounts of the coloring source compounds of the test pieces before the heat resistance tests were calculated. For example, the structure of a coloring source compound after the decomposition of the b-1, the compound having a conjugate number of 6, was derived with reference to Tetrahedron, 62 (2006), 1536-1547.

TABLE 6
(1/3)

| | | | Example | Example | Example | Example | Example | Example |
|---|---|---|---|---|---|---|---|---|
| | | | 1 | 2 | 3 | 4 | 5 | 6 |
| Aromatic polycarbonate resin (a) | | phr | 100 | 100 | 100 | 100 | 100 | 100 |
| Additive | Antioxidant (b-1) | phr | 0.01 | 0.03 | 0.05 | 0.1 | 0.15 | 0.4 |
| | Antioxidant (b-2) | phr | | | | | | |
| | Antioxidant (b-3) | phr | | | | | | |
| | Antioxidant (b-4) | phr | | | | | | |
| | Alicyclic epoxy compound (c- | phr | | | | | | |
| | 1) | | | | | | | |
| | Fatty acid ester (d-1) | phr | | | | | | |
| Kneading condition | | A/B | A | A | A | A | A | A |
| Molded | Molding condition | A1/B1 | A1 | A1 | A1 | A1 | A1 | A1 |
| body for | Amount of coloring source | [ppm] | 0.0001 | 0.0001 | 0.0002 | 0.0002 | 0.0002 | 0.0002 |
| optical | compound | | | | | | | |
| character- | 125 mm | y(Y1) | 0.3515 | 0.3515 | 0.3512 | 0.3535 | 0.3546 | 0.3580 |
| istic | 525 mm | y(Y2) | 0.3888 | 0.3878 | 0.3877 | 0.3898 | 0.3931 | 0.3982 |
| measure- | Difference (Y2-Y1) | [−] | 0.0373 | 0.0363 | 0.0365 | 0.0363 | 0.0385 | 0.0402 |
| ment | | | | | | | | |
| 5 mmt | Molding conditions | A2/B2 | A2 | A2 | A2 | A2 | A2 | A2 |
| plate | Total light transmittance | % | 90.43 | 90.24 | 90.27 | 90.25 | 90.32 | 90.28 |
| | Average spectral light | % | 86.93 | 86.46 | 86.69 | 86.93 | 86.23 | 86.21 |
| | transmittance | | | | | | | |
| | YI | [−] | 0.98 | 0.98 | 0.98 | 0.99 | 0.99 | 1.02 |
| | Amount of coloring source | [ppm] | 0.0001 | 0.0001 | 0.0001 | 0.0001 | 0.0001 | 0.0001 |
| | compound | | | | | | | |
| | LED resistance | A, B, C, D, | C | C | C | C | C | C |
| | | E | | | | | | |

(2/3)

| | | | Example | Example | Example | Example | Example | Example |
|---|---|---|---|---|---|---|---|---|
| | | | 7 | 8 | 9 | 10 | 11 | 12 |
| Aromatic polycarbonate resin (a) | | phr | 100 | 100 | 100 | 100 | 100 | 100 |
| Additive | Antioxidant (b-1) | phr | | | 0.05 | | 0.05 | |
| | Antioxidant (b-2) | phr | | | | | | |
| | Antioxidant (b-3) | phr | 0.05 | | | | | |
| | Antioxidant (b-4) | phr | | 0.05 | | 0.05 | | 0.05 |
| | Alicyclic epoxy compound (c- | phr | | | 0.1 | 0.1 | 0.1 | 0.1 |
| | 1) | | | | | | | |
| | Fatty acid ester (d-1) | phr | | | | | 0.02 | 0.02 |
| Kneading conditions | | A/B | A | A | A | A | A | A |
| Molded | Molding conditions | A1/B1 | A1 | A1 | A1 | A1 | A1 | A1 |
| body for | Amount of coloring source | [ppm] | 0.0003 | 0.0004 | 0.0001 | 0.0003 | 0.0002 | 0.0003 |
| optical | compound | | | | | | | |
| character- | 125 mm | y(Y1) | 0.3623 | 0.3589 | 0.3512 | 0.3591 | 0.3510 | 0.3592 |
| istic | 525 mm | y(Y2) | 0.3986 | 0.3974 | 0.3867 | 0.3975 | 0.3868 | 0.3976 |
| measure- | Difference (Y2-Y1) | [−] | 0.0363 | 0.0385 | 0.0355 | 0.0384 | 0.0358 | 0.0384 |
| ment | | | | | | | | |
| 5 mmt | Molding conditions | A2/B2 | A2 | A2 | A2 | A2 | A2 | A2 |
| plate | Total light transmittance | % | 90.32 | 90.28 | 90.27 | 90.30 | 90.27 | 90.27 |
| | Average spectral light | % | 83.17 | 85.71 | 86.69 | 85.72 | 86.69 | 85.72 |
| | transmittance | | | | | | | |
| | YI | [−] | 1.02 | 1.03 | 0.98 | 1.03 | 0.98 | 1.06 |
| | Amount of coloring source | [ppm] | 0.0002 | 0.0002 | 0.0001 | 0.0002 | 0.0001 | 0.0002 |
| | compound | | | | | | | |
| | LED resistance | A, B, C, D, | B | B | B | A | A | A |
| | | E | | | | | | |

(3/3)

| | | | Comparative | Comparative | Comparative | Comparative | Comparative | Comparative |
|---|---|---|---|---|---|---|---|---|
| | | | Example | Example | Example | Example | Example | Example |
| | | | 1 | 2 | 3 | 4 | 5 | 6 |
| Aromatic polycarbonate resin (a) | | phr | 100 | 100 | 100 | 100 | 100 | 100 |
| Additive | Antioxidant (b-1) | phr | 0.05 | | | 0.05 | 0.05 | 0.05 |
| | Antioxidant (b-2) | phr | | 0.05 | 0.05 | | | |
| | Antioxidant (b-3) | phr | | | | | | |
| | Antioxidant (b-4) | phr | | | | | | |
| | Alicyclic epoxy compound | phr | | | 0.1 | | 0.1 | 0.1 |
| | (c-1) | | | | | | | |
| | Fatty acid ester (d-1) | phr | | | | | | 0.02 |
| Kneading conditions | | A/B | B | A | A | B | B | B |
| Molded | Molding conditions | A1/B1 | A1 | A1 | A1 | B1 | B1 | B1 |
| body for | Amount of coloring source | [ppm] | 0.0003 | 0.0007 | 0.0008 | 0.0016 | 0.0014 | 0.0020 |
| optical | compound | | | | | | | |
| character- | 125 mm | y(Y1) | 0.3621 | 0.3755 | 0.3753 | 0.3776 | 0.3762 | 0.3804 |
| istic | 525 mm | y(Y2) | 0.4087 | 0.4338 | 0.4348 | 0.4461 | 0.4432 | 0.4486 |
| measure- | Difference (Y2-Y1) | [−] | 0.0466 | 0.0583 | 0.0595 | 0.0685 | 0.0670 | 0.0682 |
| ment | | | | | | | | |
| 5 mmt | Molding conditions | A2/B2 | A2 | A2 | A2 | B2 | B2 | B2 |
| plate | Total light transmittance | % | 89.24 | 90.28 | 90.26 | 88.35 | 88.34 | 88.31 |
| | Average spectral light | % | 85.25 | 81.77 | 81.82 | 83.14 | 83.38 | 82.96 |
| | transmittance | | | | | | | |
| | YI | [−] | 1.06 | 1.19 | 1.18 | 1.30 | 1.30 | 1.31 |
| | Amount of coloring source | [ppm] | 0.0003 | 0.0008 | 0.0006 | 0.0013 | 0.0015 | 0.0018 |
| | compound | | | | | | | |
| | LED resistance | A, B, C, D, | D | D | D | E | D | D |
| | | E | | | | | | |

The molded body formed of the polycarbonate resin composition of the present invention is suppressed from showing a change in color tone of guided light in a long light-guiding path, and is excellent in durability at the time of its irradiation with LED light. The molded body is suitable as a light-guiding part for a vehicle and various light-guiding plates, and is particularly useful as a DRL part suppressed from showing a change in color tone of guided light in a long light-guiding path.

1. A resin composition, comprising an aromatic polycarbonate resin,
wherein when colorimetry is performed by using a molded body for optical characteristic measurement formed of the resin composition, the molded body including an entering portion from which light enters, an emitting portion from which the entered light is emitted, and a light-guiding portion configured to guide the light that has entered from the entering portion to the emitting portion, and the light-guiding portion including an optical path having such a curvature that the entered light is totally reflected, and by using a white light-emitting diode as a light source,
a difference (Y2−Y1) between a y(Y1) of the molded body for optical characteristic measurement in a CIE 1931 color system at a position of a light-guiding path distant from the entering portion by 125 mm and a y(Y2) thereof in the CIE 1931 color system at a position of the light-guiding path distant from the entering portion by 525 mm is 0.055 or less, and the y(Y2) thereof in the CIE 1931 color system at the position of the light-guiding path distant from the entering portion by 525 mm is 0.40 or less.

2. The resin composition according to claim 1, further comprising an antioxidant, wherein a content of the antioxidant is 0.005 part by mass or more and 0.5 part by mass or less with respect to 100 parts by mass of the aromatic polycarbonate resin.

3. The resin composition according to claim 2, wherein a 5-millimeter thick plate, which is obtained by subjecting the resin composition to injection molding under conditions of a cylinder temperature of 260° C., a die temperature of 80° C., a cycle time of 50 seconds, and a retention time of 230 seconds, contains a coloring source compound derived from the antioxidant, the coloring source compound has a conjugate number of 10 or less, and a content of the coloring source compound in the 5-millimeter thick plate is 1 ppm or less.

4. The resin composition according to claim 2, wherein the antioxidant contains at least one of a phosphorus-based antioxidant or a phenol-based antioxidant.

5. The resin composition according to claim 1, wherein the aromatic polycarbonate resin has a viscosity-average molecular weight of 10,000 or more and 30,000 or less.

6. The resin composition according to claim 1, further comprising a fatty acid ester, wherein a content of the fatty acid ester is 0.01 part by mass or more and 0.5 part by mass or less with respect to 100 parts by mass of the aromatic polycarbonate resin.

7. The resin composition according to claim 1, wherein a 5-millimeter thick plate, which is obtained by subjecting the resin composition to injection molding under conditions of a cylinder temperature of 260° C., a die temperature of 80° C., a cycle time of 50 seconds, and a retention time of 230 seconds, has a total light transmittance of 80% or more.

8. The resin composition according to claim 1, wherein a 5-millimeter thick plate, which is obtained by subjecting the resin composition to injection molding under conditions of a cylinder temperature of 260° C., a die temperature of 80° C., a cycle time of 50 seconds, and a retention time of 230 seconds, has a YI of 1.2 or less.

9. The resin composition according to claim 1, wherein a 5-millimeter thick plate, which is obtained by subjecting the resin composition to injection molding under conditions of a cylinder temperature of 260° C., a die temperature of 80° C., a cycle time of 50 seconds, and a retention time of 230 seconds, has an average spectral light transmittance of 85.5% or more at a wavelength of from 340 nm to 400 nm.

10. The resin composition according to claim 1, further comprising an alicyclic epoxy compound, wherein a content of the alicyclic epoxy compound is 0.01 part by mass or more and 0.5 part by mass or less with respect to 100 parts by mass of the aromatic polycarbonate resin.

11. A resin molded body, comprising the resin composition of claim 1.

12. The resin molded body according to claim 11, wherein the resin molded body is an optical part.

13. The resin molded body according to claim 11,
wherein the resin composition further includes an antioxidant, and
wherein the resin molded body comprises a coloring source compound derived from the antioxidant, the coloring source compound has a conjugate number of 10 or less, and a content of the coloring source compound in the resin molded body is 1 ppm or less.

14. A method of producing the resin molded body of claim 11, comprising a step of subjecting the resin composition of any one of claims 1 to 10 to injection molding under conditions of a cylinder temperature of 220° C. or more and 300° C. or less, and a retention time of 60 seconds or more and 1,800 seconds or less.

15. A method of producing a resin molded body, comprising a step of obtaining the resin molded body by subjecting a resin composition including an aromatic polycarbonate resin and an antioxidant to injection molding under conditions of a cylinder temperature of 220° C. or more and 300° C. or less, and a retention time of 60 seconds or more and 1,800 seconds or less,
wherein the resin molded body includes a coloring source compound derived from the antioxidant, the coloring source compound has a conjugate number of 10 or less, and a content of the coloring source compound in the resin molded body is 1 ppm or less.

16. The method of producing a resin molded body according to claim 15, wherein the content of the coloring source compound in the resin molded body is 0.0002 ppm or less.
